(19) United States
(12) Patent Application Publication
(10) Pub. No.: US 2023/0145056 A1
(43) Pub. Date: May 11, 2023

(54) MOBILE ROBOT SYSTEM

(71) Applicant: Hitachi High-Tech Corporation, Tokyo (JP)

(72) Inventors: Yoshiki KANAI, Tokyo (JP); Shinichi ISHIKAWA, Tokyo (JP)

(73) Assignee: Hitachi High-Tech Corporation, Tokyo (JP)

(21) Appl. No.: 17/979,295

(22) Filed: Nov. 2, 2022

(30) Foreign Application Priority Data
Nov. 5, 2021 (JP) 2021-181096

(51) Int. Cl. B25J 9/16; B25J 13/08

(52) U.S. Cl. CPC B25J 9/1666; B25J 9/162; B25J 9/163; B25J 9/1653; B25J 13/089

(57) ABSTRACT

A mobile robot system according to the present invention includes a movement control unit including: a data management unit including environment data regarding a structure of the work target, robot data regarding a movable range of the manipulation unit and a movement range of the movement mechanism, teaching data regarding the predetermined work, and stop accuracy data that is stop accuracy of the movement mechanism; a stop position candidate search unit that searches for a workable area using the environment data, the robot data, and the teaching data to search for a stop position candidate; and a target stop position determination unit that determines a target stop position that determines a target stop position capable of executing teaching data from stop position candidates using the stop position candidates and the stop accuracy data.

### CLAIM OF PRIORITY

The present application claims priority from Japanese Patent application serial no. 2021-181096, filed on Nov. 5, 2021, the content of which is hereby incorporated by reference into this application.

### BACKGROUND OF THE INVENTION

### 1. Field of the Invention

The present invention relates to a mobile robot system that moves by a movement mechanism and executes predetermined work by a manipulation unit.

### 2. Description of the Related Art

In various sites, with labor saving and automation of work, mobile robot systems that move to the same site as a person and execute predetermined work after arriving at a target stop position have been developed and studied.

As a background art in such a technical field, for example, JP 2017-016359 A and JP 2006-159399 A are known.

JP 2017-016359 A discloses a mobile robot system including: a storage unit that stores space information indicating a position in a movement space for each partial space constituting the movement space, attribute information indicating whether or not a function failure occurs for each partial space, and a target object position indicating a position of the target object; a position estimating unit that estimates a current self-position and posture of an autonomous mobile robot; a route searching unit that sets a movement target position and calculates a movement route from the self-position to the movement target position; and a movement control unit that controls the autonomous mobile robot to move along the movement route, in which the route searching unit obtains a position where the function can be exhibited with respect to the target object from a positional relationship between the position of the partial space where a function failure occurs obtained from the space information and the attribute information and the attribute information and the target object position, and sets the movement target position at this position (see Abstract of JP 2017-016359 A).

In addition, JP 2006-159399 A discloses a work mobile robot system including: a target object position/posture acquisition unit; a moving unit; a manipulation unit, a control unit; a detection unit that acquires external information changing with the operation of the manipulation unit; a target object search unit that searches for a work target object; a grip range determination unit that determines a range in which a grip operation is possible using the manipulation unit; a movement procedure generation unit that generates a movement procedure of the moving unit; and a grip operation generation unit that generates a grip operation procedure of the manipulation unit (see Abstract of JP 2006-159399 A).

### SUMMARY OF THE INVENTION

JP 2017-016359 A and JP 2006-159399 A describe a mobile robot system that sets a movement route and a movement procedure for executing a predetermined work, and a target stop position.

However, JP 2017-016359 A and JP 2006-159399 A do not disclose a mobile robot system that determines a target stop position so that a predetermined work can be reliably executed even when a positional deviation occurs between a set stop position candidate and an actual stop position.

Furthermore, in a case where work cannot be performed at the stop position of the robot, it takes time until the robot can start work due to a correction operation of the stop position of the robot, a correction of work content, or the like.

Therefore, the present invention provides a mobile robot system that determines whether work can be performed before the start of work and obtains an appropriate moving position, thereby determining a target stop position so that a predetermined work can be reliably performed in a short time even when a positional deviation occurs between a set stop position candidate and an actual stop position.

In order to solve the above problems, a mobile robot system of the present invention is a mobile robot system including a mobile robot that moves to and stops at a target stop position in the vicinity of at least one work target, and executes predetermined work on the work target, and includes a movement mechanism and a manipulation unit mounted on the movement mechanism.

The mobile robot system includes: a data management unit including environment data regarding a structure of the work target, robot data regarding a movable range of the manipulation unit and a movement range of the movement mechanism, teaching data regarding the predetermined work, and stop accuracy data that is stop accuracy of the movement mechanism.

Then, the mobile robot system includes a movement control unit including: a stop position candidate search unit that searches for a stop position candidate where the predetermined work can be executed using the environment data, the robot data, and the teaching data so that an event that the mobile robot is outside a movable range of the manipulation unit, an event that the mobile robot is outside a movement range of the movement mechanism, and an event that the manipulation unit and the movement mechanism interfere with a structure of the work target do not occur; and a target stop position determination unit that determines a target stop position capable of executing the teaching data from the stop position candidates using the stop position candidate and the stop accuracy data.

According to the present invention, it is possible to provide a mobile robot system that determines a target stop position so that a predetermined work can be reliably performed in a short time even when a positional deviation occurs between a set stop position candidate and an actual stop position.

Other objects, configurations, and advantages of the invention will become apparent from the following description of embodiments.

### BRIEF DESCRIPTION OF THE DRAWINGS

FIG. 1 is a block diagram illustrating a configuration of a mobile robot system according to a first embodiment;

FIG. 2 is an explanatory view for explaining an appearance of a mobile robot in the first embodiment;

FIG. 3 is a flowchart illustrating a flow until the mobile robot system determines a target stop position in the first embodiment;

FIG. 4A is a flowchart illustrating a flow from movement/stop of the mobile robot to execution of teaching data according to the first embodiment;

FIG. 4B is an explanatory diagram for explaining procedures in FIG. 4A;

FIG. 5 is an explanatory diagram illustrating a data management unit of the mobile robot system according to the first embodiment;

FIG. 6 is an explanatory diagram for describing a stop position candidate search method of a stop position candidate search unit according to the first embodiment;

FIG. 7 is an explanatory diagram for explaining a target stop position determination method of a target stop position determination unit in the first embodiment;

FIG. 8 is a flowchart for explaining a flow until the mobile robot system according to the first embodiment determines a target stop position;

FIG. 9 is an explanatory view for explaining a user interface screen for determining a target stop position in the mobile robot system according to the first embodiment;

FIG. 10A is an explanatory view for explaining time-series teaching data in a target stop position determination method of a target stop position determination unit in a second embodiment; and

FIG. 10B is an explanatory view for describing a state in the vicinity of a work target in the target stop position determination method of the target stop position determination unit in the second embodiment.

### DESCRIPTION OF THE PREFERRED EMBODIMENTS

Hereinafter, embodiments of the present invention will be described with reference to the drawings. Note that, in the drawings, substantially the same or similar configurations will be described using the same reference numerals. In each drawing, if the description overlaps, the overlapping description may be omitted.

In addition, the drawings and the following examples illustrate embodiments according to the principles of the present invention and are intended to help understanding of the present invention, and are not used to interpret the present invention in a limited manner in any way. The drawings and the following examples are merely typical examples, and do not limit the scope of the claims in any sense.

Note that the present invention is not limited to the following embodiments, and includes various modifications. The following embodiments have been specifically described in order to describe the present invention in an easy-to-understand manner, and are not necessarily limited to those having all the described configurations.

Further, a part of the configuration of one embodiment can be replaced with a part of the configuration of another embodiment. In addition, the configuration of another embodiment can be added to the configuration of a certain embodiment. In addition, a part of the configuration of each embodiment can be deleted, and a part of another configuration can be added and replaced with a part of another configuration.

### First Embodiment

First, a configuration of a mobile robot system 1 according to a first embodiment will be described.

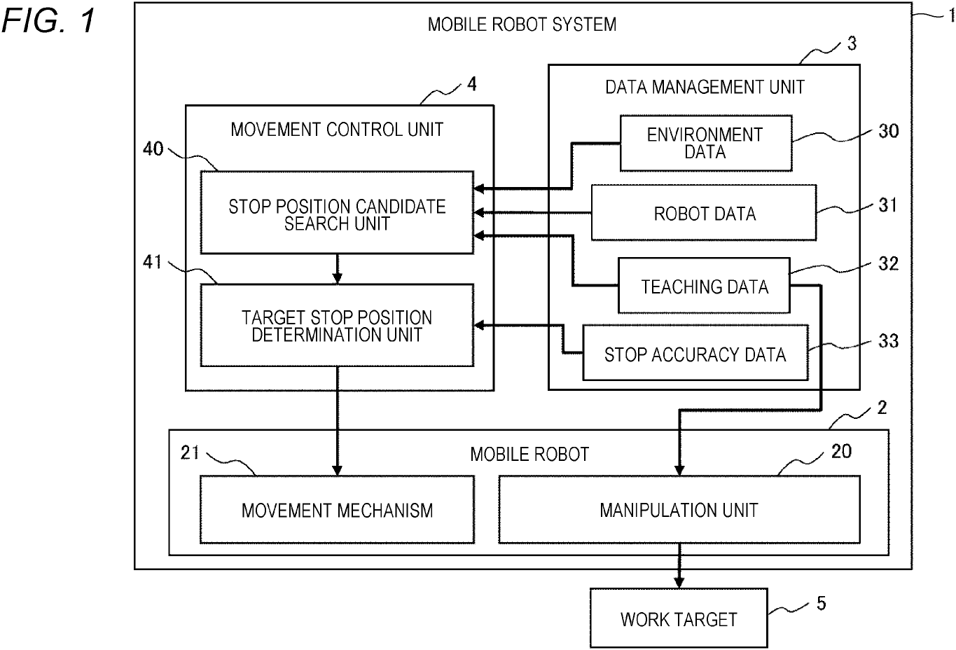

FIG. 1 is a block diagram illustrating a configuration of the mobile robot system 1 according to the first embodiment.

The mobile robot system 1 includes a mobile robot 2, a data management unit 3, and a movement control unit 4.

The mobile robot 2 includes a movement mechanism 21 and a manipulation unit 20 mounted on the movement mechanism 21. Then, the mobile robot 2 moves to and stops at a target stop position existing in the vicinity of a work target area in the vicinity of the at least one work target 5 by the movement mechanism 21, and executes predetermined work on the work target 5 by the manipulation unit 20.

The data management unit 3 includes environment data 30 having information on the size and arrangement of a structure 50 of the work target 5, robot data 31 (robot data 31 having a workable area of the mobile robot 2) having information on the size and movable range of the manipulation unit 20, the size and movement range of the movement mechanism 21, and the like, teaching data 32 in which information on a predetermined work is described, and stop accuracy data 33 having information on stop accuracy of the movement mechanism 21.

The information on the size and arrangement of the structure 50 of the work target 5 included in the environment data 30 is expressed by, for example, 3D model data of the structure 50 of the work target 5, a file in which the shape and position of the structure 50 of the work target 5 are described in a text format, or the like.

The information such as the size and movable range of the manipulation unit 20 and the size and movement range of the movement mechanism 21 included in the robot data 31 is expressed by, for example, 3D model data of the mobile robot 2 or a file in which the shape and configuration of the mobile robot 2 are described in a text format.

The information regarding the predetermined work described in the teaching data 32 is expressed by, for example, a file in which the finger position and posture information of the end effector 200 installed in the manipulation unit 20 is arranged in time series or a work procedure is described in a text format. Note that the teaching data 32 is output to the manipulation unit 20, and the end effector 200 installed in the manipulation unit 20 executes predetermined work on the work target 5 on the basis of the teaching data 32.

The information on the stop accuracy of the movement mechanism 21 included in the stop accuracy data 33 is expressed by, for example, a numerical value, a mathematical expression, a map, or the like that is uniform in all directions and spreads in a circular shape with respect to the stop position. Then, the stop accuracy data 33 may be expressed by, for example, a grid map 43 using cells 430.

The stop accuracy of the movement mechanism 21 included in the stop accuracy data 33 integrally includes a factor of a positional deviation between the set stop position candidate and the actual stop position, which occurs when the mobile robot 2 moves to an arbitrary place in the movement space, such as the control accuracy of the movement mechanism 21, the slipperiness of the movement mechanism 21 with respect to the floor surface (the movement accuracy of the moving unit), and the positioning accuracy (the detection accuracy of the detecting unit) of the position sensor (in particular, in the first embodiment, the position sensor mounted on the movement mechanism 21) used for estimating the self-position in the movement space of the movement mechanism 21.

Therefore, the stop accuracy data 33 is preferably identified in advance in the same environment and the same system.

The movement control unit 4 includes: a stop position candidate search unit 40 that searches for an area (hereinafter, a workable area) in which a predetermined work can be performed such that an event that the mobile robot is outside the movable range of the manipulation unit 20, an event that the mobile robot is outside the movement range of the movement mechanism 21, and an event that the manipulation unit 20 and the movement mechanism 21 interfere with the structure 50 of the work target 5 do not occur in the work target area in the vicinity of the work target 5, and searches for a stop position candidate (stop position candidate information); and a target stop position determination unit 41 that takes the stop accuracy data 33 into consideration and determines a target stop position (target stop position information) from the stop position candidate such that the mobile robot 2 can reliably stop in the workable area (an area including a work execution area to be described later).

The stop position candidate search unit 40 uses the environment data 30, the robot data 31, and the teaching data 32 to search for the workable area and search for a stop position candidate (workable area).

The target stop position determination unit 41 determines a target stop position using the stop position candidates and the stop accuracy data 33 acquired from the stop position candidate search unit 40, and outputs the target stop position to the movement mechanism 21.

Next, the appearance of the mobile robot 2 according to the first embodiment will be described.

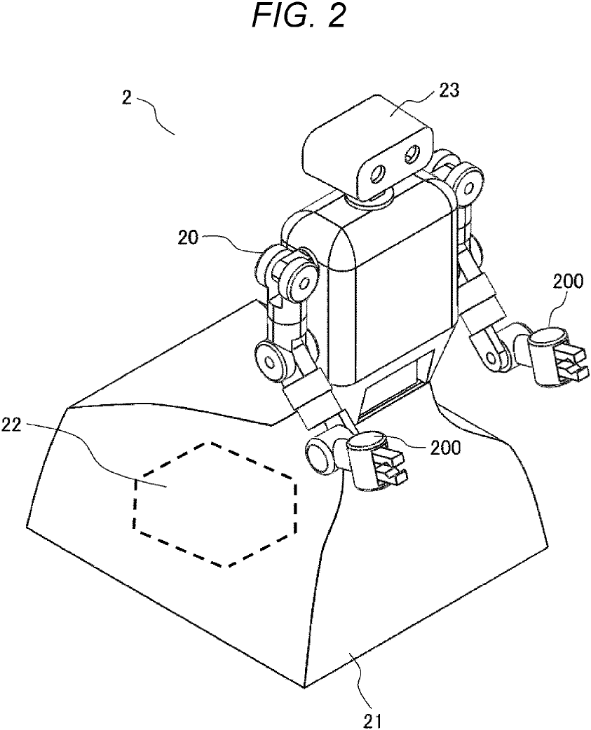

FIG. 2 is an explanatory view for explaining the appearance of the mobile robot 2 according to the first embodiment.

The mobile robot 2, which is a moving unit and a movable unit of the mobile robot system 1, includes a movement mechanism 21 mounted with an actuator and a position sensor and having one or more wheels, and a manipulation unit 20 mounted on the movement mechanism 21, mounted with an actuator and a position sensor, and having a plurality of joints.

Note that the position sensor mounted on the movement mechanism 21 and the position sensor mounted on the manipulation unit 20 are used when the self-position of the movement mechanism 21 in the movement space is estimated. In the first embodiment, the position sensor is mounted on the movement mechanism 21 and the manipulation unit 20, but may be mounted on the movement mechanism 21 or the manipulation unit 20.

The movement mechanism 21 includes a robot control unit 22 that controls wheels and joints.

The manipulation unit 20 includes an end effector 200 that grips a gripping target object 51 in the work target 5, and a relative positional relationship acquisition unit 23 that recognizes the work target 5 and acquires a relative positional relationship (relative positional relationship information) between the end effector 200 and the work target 5. Note that, in the first embodiment, the relative positional relationship acquisition unit 23 has a function of a position sensor mounted on the manipulation unit 20.

That is, the manipulation unit 20 includes the relative positional relationship acquisition unit 23 that recognizes the work target 5 and acquires the relative positional relationship between the manipulation unit 20 (the mobile robot 2 in a broad sense, and the end effector 200 in a narrow sense) and the work target 5 after the movement mechanism 21 stops at the target stop position.

The data management unit 3 and/or the movement control unit 4 may be installed inside the mobile robot 2, particularly in the robot control unit 22, or may be installed outside the mobile robot 2.

Next, a flow F1 until the mobile robot system 1 according to the first embodiment determines the target stop position will be described.

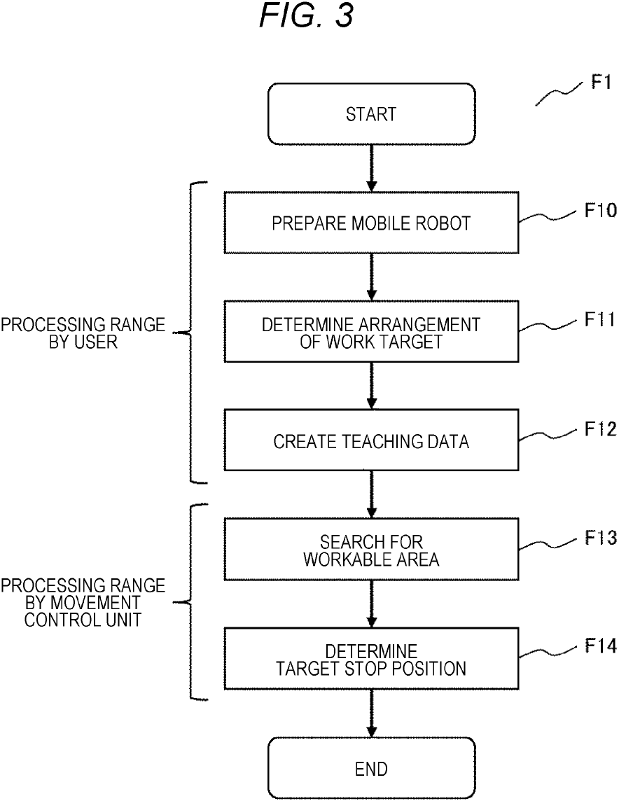

FIG. 3 is a flowchart illustrating a flow F1 until the mobile robot system 1 according to the first embodiment determines a target stop position.

In procedure F10, the mobile robot 2 to be used is prepared, and at the same time, the robot data 31 and the stop accuracy data 33 are acquired.

In procedure F11, the arrangement of the gripping target object 51 in the work target 5 is determined, and at the same time, the environment data 30 is acquired.

In procedure F12, the arrangement of the gripping target object 51 in the work target 5 is determined, and at the same time, the teaching data 32 for teaching the arrangement of the gripping target object 51 in the work target 5 of the structure 50 of the work target 5 to the mobile robot 2 in a state where the environment data 30 is acquired is created.

Note that procedure F10, procedure F11, and procedure F12 are procedures processed by the user (processing range by the user).

In procedure F13, the stop position candidate search unit 40 acquires the environment data 30, the robot data 31, and the teaching data 32, and then searches for a workable area and a stop position candidate using the environment data 30, the robot data 31, and the teaching data 32.

In procedure F14, the target stop position determination unit 41 determines a target stop position using the stop position candidates and the stop accuracy data 33, and moves the mobile robot 2.

Note that procedure F13 and procedure F14 are procedures to be processed by the movement control unit 4 (processing range by the movement control unit 4), and are procedures to be processed in a software manner before the movement of the mobile robot 2.

As a result, according to the first embodiment, the determination of the target stop position and the execution of the teaching data 32 can be guaranteed in advance (before the movement of the mobile robot 2) as compared with the case where the work target 5 is detected and the set stop position candidate is corrected after the movement of the mobile robot 2, so that the operation time of the mobile robot 2 can be shortened.

Next, a flow F2 from movement/stop of the mobile robot 2 to execution of the teaching data 32 (work execution procedure of the teaching data 32 after the mobile robot 2 is stopped) in the first embodiment will be described.

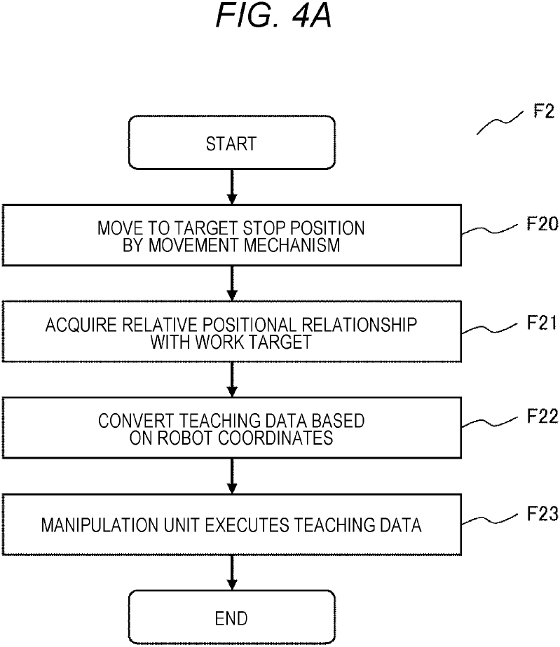

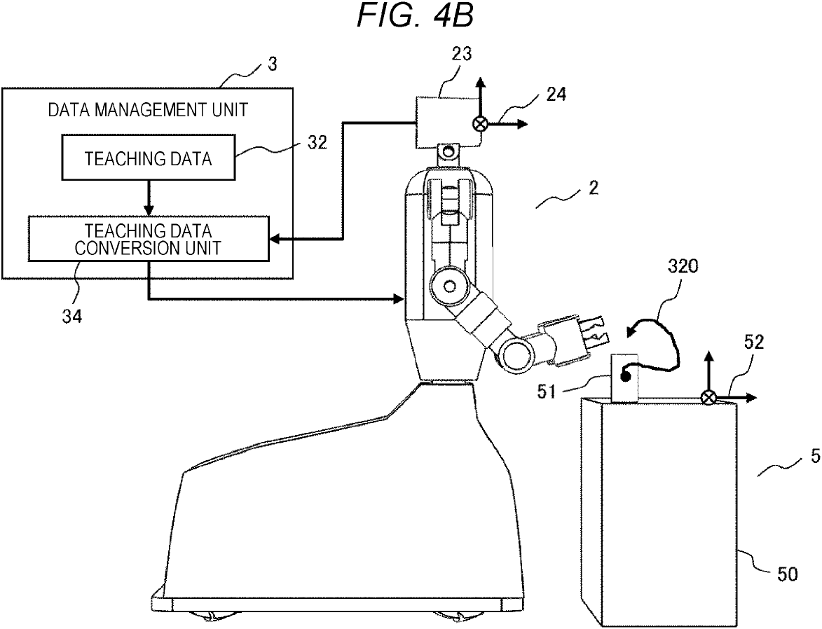

FIG. 4A is a flowchart illustrating a flow F2 from the movement/stop of the mobile robot 2 to the execution of the teaching data 32 according to the first embodiment.

In procedure F20, the movement mechanism 21 causes the mobile robot to move to the determined target stop position and stop at the determined target stop position.

In procedure F21, the relative positional relationship acquisition unit 23 acquires the relative positional relationship between the end effector 200 and the work target 5.

In procedure F22, the teaching data 32 is converted into data executable by the mobile robot 2 based on the acquired relative positional relationship. That is, based on the acquired relative positional relationship, a teaching data conversion unit 34 installed in the data management unit 3 converts the teaching data 32 into data (robot coordinate data) expressed with reference to a robot coordinate system (coordinate system fixed to the mobile robot 2). As described above, the data management unit 3 includes the teaching data conversion unit 34 that converts the teaching data 32 into data based on the robot coordinate system based on the acquired relative positional relationship.

In procedure F23, the manipulation unit 20 executes the converted teaching data 32. As a result, the manipulation unit 20 can execute a predetermined work.

Next, procedure F21 and procedure F22 in FIG. 4A will be described.

FIG. 4B is an explanatory diagram illustrating procedure F21 and procedure F22 in FIG. 4A.

The work target 5 includes the structure 50 and the gripping target object 51.

The teaching data 32 is expressed as a point trajectory (that is, a teaching data trajectory 320) of the position and posture of the distal end (finger) of the end effector 200 when the gripping target object 51 is gripped by the end effector 200.

The teaching data 32 is data expressed with reference to a coordinate system (work target coordinate system 52) fixed to the work target 5, and the teaching data trajectory 320 is stored in the data management unit 3 as finger position and posture information of the end effector 200 with reference to the work target coordinate system 52 which is a coordinate system fixed to the work target 5.

In procedure F21, the relative positional relationship acquisition unit 23 acquires the relative positional relationship between the robot coordinate system 24, which is a coordinate system fixed to the mobile robot 2, and the work target coordinate system 52.

In procedure F22, based on the acquired relative positional relationship, the teaching data conversion unit 34 converts the teaching data 32 into data based on the robot coordinate system 24, which is data executable by the mobile robot 2. Then, the joint angle of the manipulation unit 20 is controlled such that the distal end (finger) of the end effector 200 overlaps the position and posture of the converted data. As a result, the end effector 200 can follow the teaching data trajectory 320.

Next, the data management unit 3 of the mobile robot system 1 according to the first embodiment will be described.

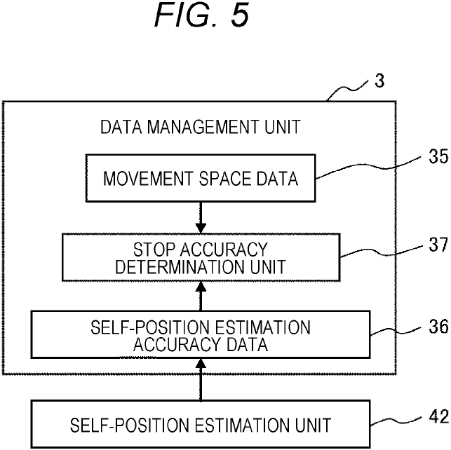

FIG. 5 is an explanatory diagram illustrating the data management unit 3 of the mobile robot system 1 according to the first embodiment.

The data management unit 3 includes a stop accuracy determination unit 37 that determines the stop accuracy data 33.

In the factor of a positional deviation between the set stop position candidate and the actual stop position, in particular, a positional deviation due to the sliding of the movement mechanism 21 with respect to the floor surface may differ depending on the position in the movement space. Furthermore, the positioning accuracy of the position sensor used for estimating the self-position in the movement space may change depending on the position in the movement space.

Therefore, in the data management unit 3, in order to make the stop accuracy data 33 variable depending on the position in the movement space, the stop accuracy determination unit 37 determines the stop accuracy data 33 using movement space data 35 and self-position estimation accuracy data 36.

The movement space data 35 is environment information of the movement space in which the movement mechanism 21 is movable, which affects the movement or stop of the movement mechanism 21 at a position in an arbitrary movement space, and is expressed by, for example, a mathematical expression or a map of the sliding amount of the movement mechanism 21 with respect to the floor surface in the movement space, information indicating the condition of the floor surface, or the like.

The self-position estimation accuracy data 36 is information (for example, a distance to a positioning target such as a wall or a column of a work room) of self-position estimation accuracy that affects the movement or stop of the movement mechanism 21, estimated by the self-position estimation unit 42 installed in the movement control unit 4, at a position in an arbitrary movement space, and is expressed by, for example, a mathematical expression or a map of the self-position estimation accuracy, information indicating a position sensor to be used, or the like.

As described above, the movement control unit 4 includes the self-position estimation unit 42 that estimates the self-position and posture of the mobile robot 2 in the movement space, and the self-position estimation unit 42 estimates the self-position estimation accuracy data 36.

As a result, the change in the stop accuracy of the movement mechanism 21 at the position in the movement space can be reflected in the determination of the target stop position.

Note that by spreading tiles or the like having a uniform floor surface condition on the floor surface in the movement space, or by separately arranging a positioning target serving as a hint for estimating the self-position in the movement space, it is also possible to eliminate a change in the stop accuracy of the movement mechanism 21 depending on the position in the movement space.

Next, a stop position candidate search method of the stop position candidate search unit 40 according to the first embodiment will be described.

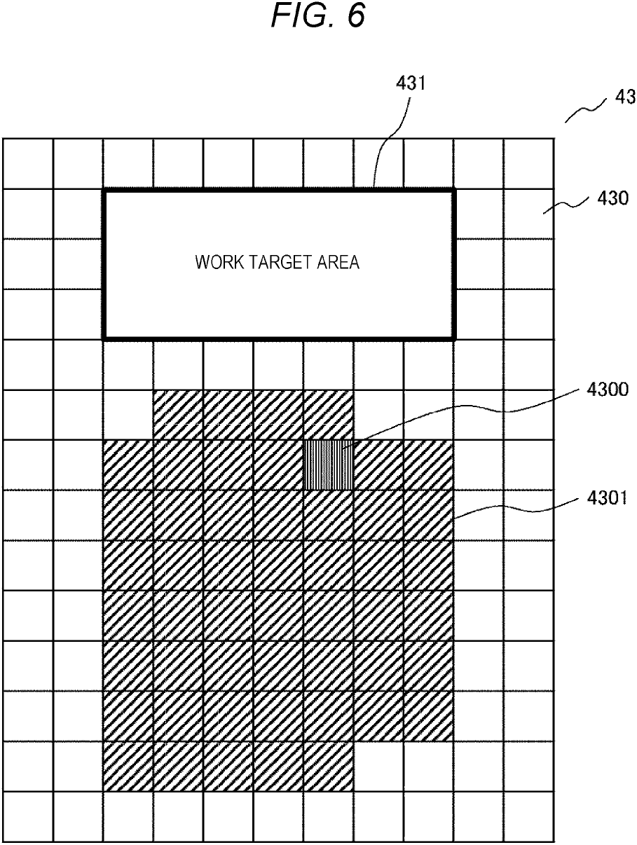

FIG. 6 is an explanatory diagram illustrating a stop position candidate search method of the stop position candidate search unit 40 according to the first embodiment.

When searching for a stop position candidate, the stop position candidate search unit 40 determines whether or not a predetermined work can be executed (whether or not the work can be executed) and searches for a stop position candidate for each cell 430 (search point having constant front, rear, left, and right widths) arranged at constant intervals (lattice shape) in front, rear, left, and right directions in the grid map 43 in the vicinity of the work target area 431 where the work target 5 exists.

That is, when searching for the stop position candidate, the stop position candidate search unit 40 uses the grid map 43 which is divided into a plurality of cells 430 at regular intervals in the front, rear, left, and right directions in the vicinity of the work target area 431 near the work target 5 to determine whether or not the work can be performed for each cell 430 (constant search width in the front, rear, left, and right directions), and searches for the stop position candidate (cell 430 for which the work can be performed).

The mobile robot 2 is stopped at a certain cell 430 in the vicinity of the work target area 431, and the end effector 200 installed in the manipulation unit 20 is actually operated on the basis of the teaching data 32. When the end effector 200 is operated (when the teaching data 32 can be created), this cell 430 (the stop position candidate searched first) is set as the teaching point 4300 and is set as the start point of the search for the stop position candidate. Starting from the teaching point 4300, stop position candidates are searched for in the front, rear, left, and right cells 430.

Then, when searching for stop position candidates, the mobile robot is stopped at a certain cell 430, and stop position candidates are searched for based on the teaching data 32 while determining that the cell is a workable point 4301 as the workable area when the mobile robot 2 is within the movement range of the end effector 200 (within the movable range of the manipulation unit 20) and when the end effector 200 (the manipulation unit 20) does not interfere with the structure 50 of the work target 5. The teaching point 4300 is the first workable point 4301.

Then, similarly, stop position candidates are searched for in cells 430A (defined for convenience of description) on four sides (adjacent to the front, rear, left, and right) of the teaching point 4300. Further, stop position candidates are searched for in cells 430B (defined for convenience of description) adjacent to the four sides of the cell 430A, and stop position candidates are searched for in cells 430C (defined for convenience of description) adjacent to the four sides of the cell 430B.

In addition, in the cell 430 in which the stop position candidate is searched for, when the mobile robot is out of the movement range of the end effector 200 (out of the movable range of the manipulation unit 20) or when the end effector 200 (manipulation unit 20) interferes with the structure 50 of the work target 5, the cell is determined as a non-workable point, and the search for the stop position candidate is terminated for the cell 430 and the subsequent cells. Note that an arbitrary range may be designated for the cell 430 in the vicinity of the work target area 431, and the search for the stop position candidate may be terminated when the cell is out of the range.

In this manner, stop position candidates which are a set of a plurality of workable points 4301 (a set of a plurality of cells 430) are searched for.

By setting the teaching point 4300 at which the execution of the predetermined work is guaranteed as the start point of the search for the stop position candidate and searching for the stop position candidate, it is possible to search for the stop position candidate with less calculation cost than the case of searching all the work target areas 431 in the vicinity of the work target 5.

Next, a target stop position determination method of the target stop position determination unit 41 according to the first embodiment will be described.

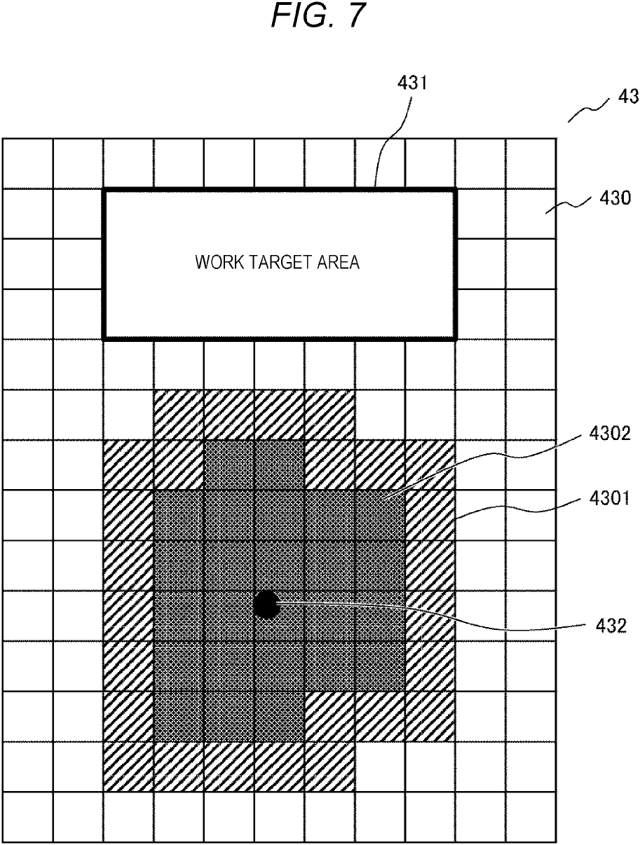

FIG. 7 is an explanatory diagram illustrating a target stop position determination method of the target stop position determination unit 41 according to the first embodiment.

The target stop position determination unit 41 acquires a work execution guarantee point 4302 in which the execution of the predetermined work is guaranteed in consideration of the stop accuracy data 33 with respect to the stop position candidates which are a set of the plurality of workable points 4301.

When the work execution guarantee point 4302 is acquired as one cell 430, the one cell 430 is determined as the target stop position. When the work execution guarantee point 4302 is acquired as a plurality of cells 430, a barycentric position 432 of the plurality of cells 430 (the work execution area which is a set of the plurality of work execution guarantee points 4302) is determined as the target stop position.

Accordingly, in the work execution guarantee point 4302, the cell 430 having the highest tolerance of the stop accuracy of the movement mechanism 21 can be determined as the target stop position.

The interval between the cells 430 in the grid map 43 is preferably a value that depends on the stop accuracy data 33. For example, when the stop accuracy of the movement mechanism 21 is set to a circle of ±Rmm, it is preferable to set the interval between the cells 430 to Rmm or more.

When the work execution guarantee point 4302 is acquired, if the cells 430 in eight directions (front, back, left, right, front left, front right, back left, back right) of a certain workable point 4301 are similarly the workable point 4301, the cells 430 can be acquired as the work execution guarantee point 4302. As a result, the work execution guarantee point 4302 can be acquired with a small calculation cost.

Next, a flow F11 until the mobile robot system 1 according to the first embodiment determines the target stop position will be described.

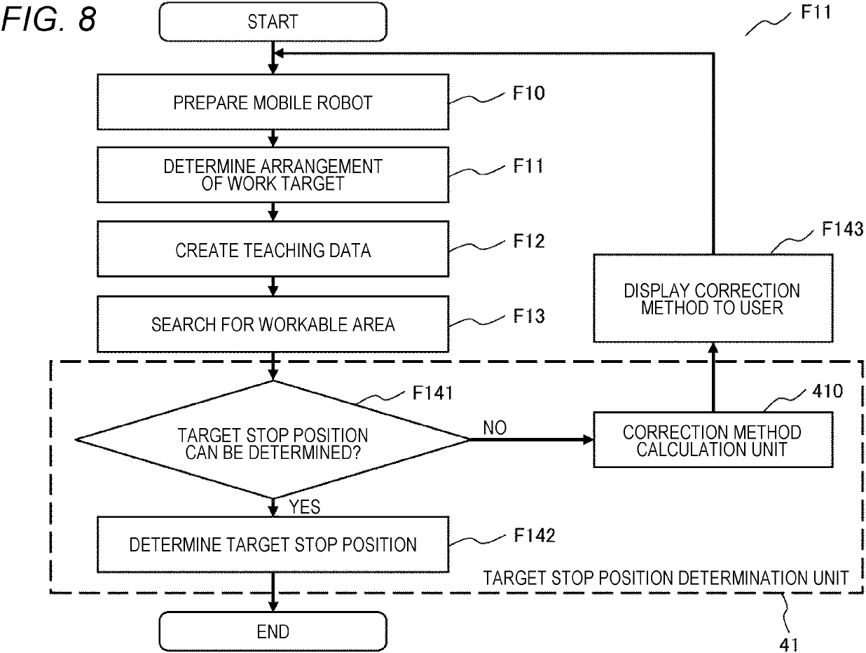

FIG. 8 is a flowchart illustrating a flow F11 until the mobile robot system 1 according to the first embodiment determines a target stop position.

Here, a flow F11 when the target stop position cannot be determined in procedure F14 in the flow F1 illustrated in FIG. 3 is illustrated.

In procedure F141, the target stop position determination unit 41 determines whether the target stop position can be determined. That is, it is determined whether the work execution guarantee point 4302 can be acquired. When the target stop position can be determined (YES), the process proceeds to procedure F142, and when the target stop position cannot be determined (NO), the process proceeds to procedure F143.

If it is determined in procedure F141 that the target stop position can be determined (YES), the target stop position determination unit 41 determines the target stop position and moves the mobile robot 2 in procedure F142.

When it is determined in procedure F14 that the target stop position cannot be determined (NO), the correction method calculation unit 410 set in the target stop position determination unit 41 corrects at least one of the influence factors affecting the determination of the target stop position, such as the configuration of the manipulation unit 20, the condition of the floor surface, the arrangement of the structure 50 of the work target 5, and the teaching data 32, or displays the correction to the user. That is, at least one of the influence factors is corrected such that there is a target stop position satisfying the condition of the target stop position determination unit 41, or the correction is displayed to the user.

The correction method calculation unit 410 corrects the influence factor or displays the correction to the user by the following correction method, for example.
Correction method (1): The configuration of the manipulation unit 20 is changed so as to widen the movable range of the manipulation unit 20.
Correction method (2): The position sensor is changed and the condition of the floor surface is changed so that the stop accuracy of the movement mechanism 21 is improved.
Correction method (3): The arrangement of the structure 50 of the work target 5 is changed so that the manipulation unit 20 can easily operate.
Correction method (4): The teaching data 32 is changed so as not to interfere with the structure 50 of the work target 5.

In the correction such as the correction method (1) or the correction method (2), it is necessary to change the hardware configuration of the mobile robot 2. Therefore, the correction such as the correction method (3) and/or the correction method (4) is preferable. As a result, the number of user processing steps required for correction can be reduced.

Then, when it is determined in procedure F141 that the target stop position cannot be determined (NO), the correction method calculation unit 410 displays the correction content of the influence factor to the user in procedure F143, and the process returns to procedure F10.

Regarding the correction of the influence factor, the user corrects at least one of procedure F10, procedure 11, and procedure F12 on the basis of the displayed correction content of the influence factor.

Furthermore, the correction of the influence factor may be automatically executed by software processing. For example, when the teaching data 32 is changed (the positions of some data points of the teaching data 32 are changed), the data points may be automatically changed. As a result, reworking to the user can be eliminated, and the number of user processing steps can be reduced.

Next, a user interface screen G1 for determining a target stop position in the mobile robot system 1 according to the first embodiment will be described.

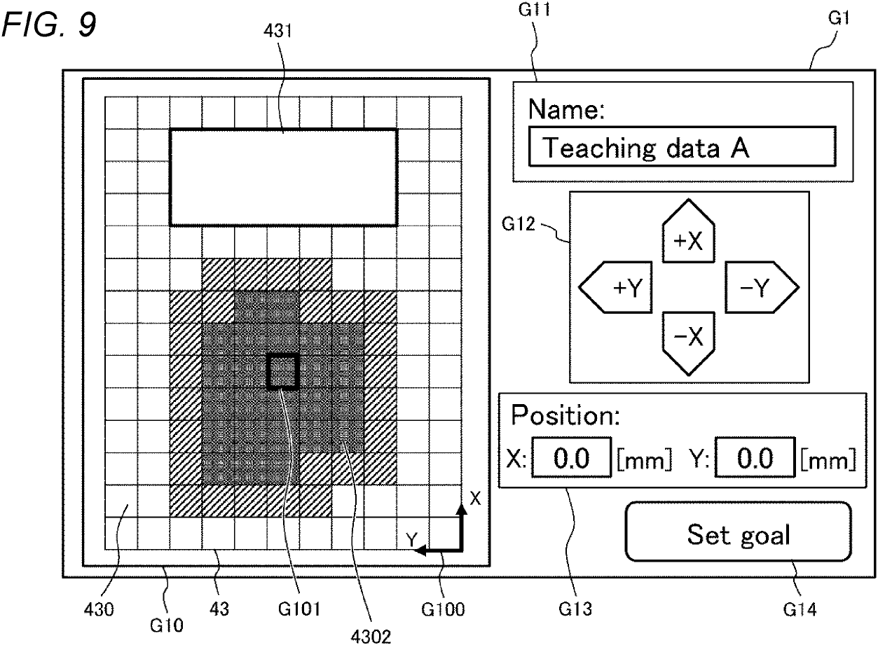

FIG. 9 is an explanatory view for explaining the user interface screen G1 for determining a target stop position in the mobile robot system 1 according to the first embodiment.

The user interface screen (display unit) G1 displays the grid map 43, a map coordinate system G100, and a target stop position selection cursor G101 and includes a map display unit G10 that displays the vicinity of the work target 5 and the target stop position, a teaching data name display unit G11 that displays the name of the teaching data 32, a cursor movement button G12 that moves a target stop position selection cursor G101 and selects the target stop position, a cursor position information display unit G13 that displays position information of the target stop position selection cursor G101, and a target stop position setting button G14 that sets the target stop position.

The target stop position selection cursor G101 selects only the work execution guarantee point 4302, and the user can determine an arbitrary work execution guarantee point 4302 as the target stop position.

In general, in the mobile robot system 1, in a case where a positional deviation occurs between the set stop position candidate and the actual stop position and the teaching data 32 cannot be executed, an event that the mobile robot is outside the movement range of the movement mechanism 21, an event that the mobile robot is outside the movable range of the manipulation unit 20, and an event that the manipulation unit 20 or the movement mechanism 21 interferes with the structure 50 of the work target 5 at the time of executing the work may occur.

Therefore, the mobile robot system 1 according to the first embodiment searches for a workable area in which an event that the mobile robot is outside the movement range of the movement mechanism 21, an event that the mobile robot is outside the movable range of the manipulation unit 20, and an event that the manipulation unit 20 and the movement mechanism 21 interfere with the structure 50 of the work target 5 do not occur in the work target area 431 in the vicinity of the work target 5 on the basis of the teaching data 32, the robot data 31, and the environment data 30, searches for a stop position candidate, and adds the stop accuracy data 33 which is the stop accuracy of the movement mechanism 21 to the stop position candidate, thereby determining a target stop position at which the mobile robot 2 can reliably stop in the work execution area (an area inside the workable area).

That is, according to the first embodiment, the target stop position can be determined such that the predetermined work can be reliably executed even when a positional deviation occurs between the set stop position candidate and the actual stop position.

Furthermore, according to the first embodiment, the target stop position can be determined so that the predetermined work can be reliably executed without depending on the movement accuracy of the moving unit or the detection accuracy of the detecting unit.

Further, according to the first embodiment, the time for the mobile robot 2 to converge to the target stop position can be shortened, and the operation time of the mobile robot 2 can be shortened.

Further, according to the first embodiment, in particular, even in a case where the area where the predetermined work is executed is narrow, the mobile robot 2 can easily stop in the area.

As described above, the present system can reliably execute a predetermined work in a short time even when a positional deviation occurs between the set stop position candidate and the actual stop position.

### Second Embodiment

Next, a target stop position determination method of a target stop position determination unit 41 according to a second embodiment will be described.

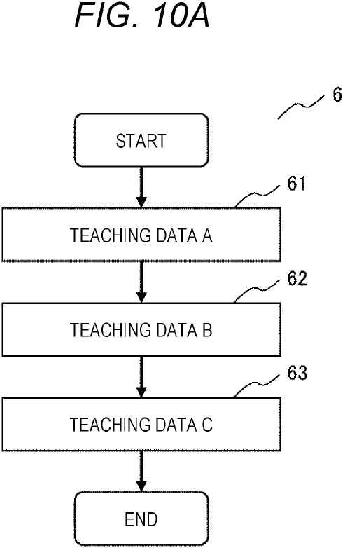

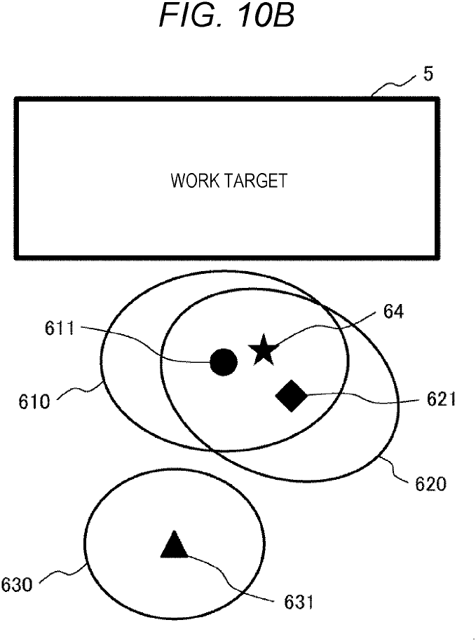

FIG. 10A is an explanatory view for describing the time-series teaching data 6 in a target stop position determination method of the target stop position determination unit 41 in the second embodiment, and FIG. 10B is an explanatory view for describing a state in the vicinity of the work target 5 in a target stop position determination method of the target stop position determination unit 41 in the second embodiment.

In the second embodiment, parts different from the first embodiment will be described. Portions not described in the second embodiment are the same as those in the first embodiment.

FIG. 10A illustrates time-series teaching data 6 having at least two pieces of teaching data 32 for one work target 5. In the second embodiment, the data management unit 3 includes, for example, three pieces of teaching data 32, and the three pieces of teaching data 32 are executed in the order of teaching data A61, teaching data B62, and teaching data C63 as the time-series teaching data.

FIG. 10B illustrates a state in the vicinity of one work target 5, in which the workable area is searched for the teaching data A61, the teaching data B62, and the teaching data C63 included in the time-series teaching data 6.

FIG. 10B illustrates the workable area 610 related to the teaching data A61 and the target stop position 611 determined therefrom, the workable area 620 related to the teaching data B62 and the target stop position 621 determined therefrom, and the workable area 630 related to the teaching data C63 and the target stop position 631 determined therefrom.

Thus, when the time-series teaching data 6 is executed, the target stop position is determined for all the teaching data (teaching data A61, teaching data B62, and teaching data C63) included in the time-series teaching data 6.

That is, when the teaching data 32 is a plurality of pieces of time-series teaching data (time-series teaching data 6) for a predetermined work, the target stop position determination unit 41 determines the target stop position for each of all pieces of teaching data (teaching data A61, teaching data B62, and teaching data C63).

When the predetermined work is executed, the standing position of the mobile robot 2 may be changed to the target stop position for each teaching data, and each teaching data may be executed at each target stop position.

When the predetermined work is executed, the workable areas (stop position candidates) overlap each other in the continuous teaching data, and the same (one) target stop position can be determined for the overlapping workable areas (stop position candidates), each teaching data may be executed at the same target stop position.

That is, the target stop position determination unit 41 determines the same target stop position for an area (workable area) in which areas (workable areas) that form a stop position candidate overlap (are common) in a plurality of pieces of time-series teaching data, that is, at least two successive pieces of teaching data, and which forms the overlapping (common) stop position candidates.

For example, in the second embodiment, the workable area of the teaching data A61 and the workable area of the teaching data B62 overlap with each other, and the common target stop position 64 between the teaching data A61 and the teaching data B62 is determined in consideration of the stop accuracy data 33 which is the stop accuracy of the movement mechanism 21 for the overlapping workable area. In this case, the mobile robot 2 first moves to the target stop position 64, executes the teaching data A61 and the teaching data B62, then moves to the target stop position 631, and executes the teaching data C63.

The teaching data may be corrected so that all the teaching data included in the time-series teaching data 6 can be executed at the common target stop position.

In this case, the teaching data to be corrected is selected so that the workable areas of all the teaching data overlap with each other, the target stop position can be determined for the overlapping workable area, and the number of pieces of teaching data to be corrected is minimized, and the correction method calculation unit 410 corrects the selected teaching data in the same manner as in the first embodiment.

However, since the correction method (1), the correction method (2), and the correction method (3) described in the first embodiment affect the workable area of all the teaching data, it is preferable to perform correction by the correction method (4).

That is, the target stop position determination unit 41 includes the correction method calculation unit 410 that corrects at least one of the influence factors affecting the determination of the target stop position, and when correcting the teaching data, the correction method calculation unit 410 selects the teaching data to be corrected so that the number of pieces of teaching data to be corrected is minimized.

Then, for each teaching data, the teaching data is corrected so that the workable areas of all the teaching data overlap based on the range information of the workable area of each teaching data.

That is, when there is no target stop position satisfying the condition of the target stop position determination unit 41 for all the teaching data, the target stop position determination unit 41 calculates a range of stop position candidates in each teaching data for each teaching data, and selects the teaching data to be corrected based on the calculated range of stop position candidates such that there is a target stop position satisfying the condition of the target stop position determination unit 41 and the number of pieces of teaching data to be corrected is minimized.

For example, in the second embodiment, only the teaching data C63 needs to be corrected based on the range information of the workable area of each teaching data since the workable areas of all the teaching data overlap. After correcting only the teaching data C63, the mobile robot 2 moves to the common target stop position for all the teaching data, and executes all the teaching data.

According to the second embodiment, even when there is a plurality of pieces of teaching data to be executed, the target stop position can be determined so that the predetermined work can be reliably executed in a short time.

1. A mobile robot system including a mobile robot that moves to and stops at a target stop position in the vicinity of at least one work target, and executes predetermined work on the work target, and includes a movement mechanism and a manipulation unit mounted on the movement mechanism, the mobile robot system comprising:
a data management unit including environment data regarding a structure of the work target, robot data regarding a movable range of the manipulation unit and a movement range of the movement mechanism, teaching data regarding the predetermined work, and stop accuracy data that is stop accuracy of the movement mechanism; and
a movement control unit including a stop position candidate search unit that searches for a stop position candidate where the predetermined work can be executed using the environment data, the robot data, and the teaching data so that an event that the mobile robot is outside a movable range of the manipulation unit, an event that the mobile robot is outside a movement range of the movement mechanism, and an event that the manipulation unit and the movement mechanism interfere with a structure of the work target do not occur and a target stop position determination unit that determines a target stop position capable of executing the teaching data from the stop position candidates using the stop position candidate and the stop accuracy data.

2. The mobile robot system according to claim 1, wherein
the manipulation unit includes a relative positional relationship acquisition unit that recognizes the work target and acquires a relative positional relationship between the manipulation unit and the work target.

3. The mobile robot system according to claim 2, wherein
the data management unit includes a teaching data conversion unit that converts the teaching data based on a coordinate system fixed to the work target into data based on a robot coordinate system based on the relative positional relationship.

4. The mobile robot system according to claim 1, wherein
the data management unit includes a stop accuracy determination unit that determines the stop accuracy data.

5. The mobile robot system according to claim 4, wherein
the stop accuracy determination unit determines the stop accuracy data using movement space data that is information on a movement space in which the movement mechanism can move and self-position estimation accuracy data that is information on self-position estimation accuracy that affects movement or stop of the movement mechanism.

6. The mobile robot system according to claim 1, wherein
the stop position candidate search unit uses a plurality of cells in the vicinity of the work target, determines whether work can be performed for each cell, and searches for a stop position candidate.

7. The mobile robot system according to claim 6, wherein
the target stop position determination unit acquires a work execution guarantee point at which execution of the predetermined work is guaranteed in consideration of the stop accuracy data with respect to the stop position candidate, and determines a barycentric position as the target stop position when a plurality of work execution guarantee points are acquired.

8. The mobile robot system according to claim 1, further comprising:
a display unit that displays a vicinity of the work target and the target stop position.

9. The mobile robot system according to claim 1, wherein
the target stop position determination unit includes a correction method calculation unit that corrects at least one of influence factors affecting the determination of the target stop position.

10. The mobile robot system according to claim 1, wherein
when the teaching data is a plurality of pieces of time-series teaching data for the predetermined work, the target stop position determination unit determines the target stop position for all the pieces of teaching data.

11. The mobile robot system according to claim 10, wherein
the target stop position determination unit determines, when the stop position candidates overlap each other in the time-series teaching data, the same target stop position for the overlapping stop position candidates.

12. The mobile robot system according to claim 1, wherein
the target stop position determination unit includes a correction method calculation unit that corrects at least one of influence factors affecting determination of the target stop position, and
when correcting the teaching data, the correction method calculation unit selects the teaching data to be corrected so that the number of pieces of teaching data to be corrected is minimized.
